(19) United States
(12) Patent Application Publication
(10) Pub. No.: US 2024/0393754 A1
(43) Pub. Date: Nov. 28, 2024

(54) APPARATUS AND COMPUTER-IMPLEMENTED METHOD FOR CLASSIFYING DATA

(71) Applicant: Robert Bosch GmbH, Stuttgart (DE)

(72) Inventors: Wei Zhou, Stuttgart (DE); Heike Adel-Vu, Renningen (DE); Hendrik Schuff, Mainz (DE); Ngoc Thang Vu, Renningen (DE)

(21) Appl. No.: 18/665,700

(22) Filed: May 16, 2024

(30) Foreign Application Priority Data
May 22, 2023 (DE) 10 2023 204 764.0

(51) Int. Cl. G05B 17/02

(52) U.S. Cl. CPC G05B 17/02

(57) ABSTRACT

An apparatus and computer-implemented method for classifying data. A first classification is determined as a function of the data using a first model. A measure for a contribution of the relevant part to the classification is in each case determined for parts of the data to be classified. The data are supplemented by at least one of the parts, for which, as a function of the measures determined for the parts, it is determined that the at least one of the parts to be classified contributes more to the first classification than other parts to be classified. A second classification is determined as a function of the data supplemented by the at least one of the parts using the first model or using a second model.

### FIELD

The present invention relates to an apparatus and a computer-implemented method for classifying data.

### BACKGROUND INFORMATION

The classification of data can be used to automate technical systems.

### SUMMARY

Through the computer-implemented method and the apparatus according to features of the present invention, the classification of data is based on additional knowledge about the data.

According to an example embodiment of the present invention, the computer-implemented method for classifying data provides that a first classification is determined as a function of the data using a first model, wherein a measure for a contribution of the relevant part to the classification is in each case determined for parts of the data to be classified, wherein the data are supplemented by at least one of the parts, for which, as a function of the measures determined for the parts, it is determined that the at least one of the parts to be classified contributes more to the first classification than other parts to be classified, and wherein a second classification is determined as a function of the data supplemented by the at least one of the parts using the first model or using a second model. The measure represents a salience of the respective parts to be classified. The second classification additionally uses the most salient of the parts to be classified or the most salient of the parts to be classified from the original parts to be classified. As a result, the second classification is improved compared to the first classification.

According to an example embodiment of the present invention, it can be provided that the parts of the data to be classified represent a state of a technical system, wherein the first classification comprises a first class for the state of the technical system and a second class for the state of the technical system, wherein the second classification comprises the first class and the second class, and wherein the state is determined as a function of the second classification. The data are, for example, reports that are automatically generated by the technical system. For example, a log file containing these data is provided. For example, the first class is assigned to an error state of the technical system. The second class, for example, is assigned to a normal state of the technical system. The classes can also be provided for other states, for example for an anomaly or a differentiated specification of a relevant error state or an affected part of the technical system.

According to an example embodiment of the present invention, it can be provided that the second classification is determined using the second model, wherein the first model is or will be trained to classify the data of the technical system, wherein the second model is or will be pre-trained independently of the technical system. The salience is determined using a first model trained for the technical system. The second model can, but does not have to, be specifically trained for the technical system.

According to an example embodiment of the present invention, it can be provided that the first model and/or the second model comprises a differentiable model, in particular a transformer model. The salience can be determined particularly well using said model.

According to an example embodiment of the present invention, it can be provided that the data comprise at least one part that defines a task for which the classification is determined. The task is a prompt that is used to influence the first model for outputting a first classification specific to the task or to influence the second model for outputting a second classification specific to the task.

According to an example embodiment of the present invention, it can be provided that the data comprise at least one part that is masked with a mask, wherein the first model and/or the second model is designed to determine the part masked with the mask as a function of the first classification or as a function of the second classification. This means that the first model and/or the second model can be designed as a masked language model.

According to an example embodiment of the present invention, it can be provided that the data comprise at least one part associated with a class, wherein the first model and/or the second model is designed to select the part masked with the mask from the first classification or the second classification as a function of the at least one part associated with the class. The at least one part associated with the class is, for example, a verbalizer for the masked language model. The first classification and the second classification provide possible solutions for the part masked with the mask. By means of the verbalizer, the solution for the part masked with the mask in the first or the second classification is selected only from a subset of all possible solutions that comprises solutions associated with the class of the verbalizer. As a result, the classification can be further improved or adjusted.

Preferably, according to an example embodiment of the present invention, the data are supplemented by a predefined number or a predefined percentage of the parts of the data to be classified. As a result, the classification can be further improved or adjusted.

According to an example embodiment of the present invention, it can be provided that the data comprise a part that is associated with at least one entity or relation from a knowledge graph, wherein an entry for the knowledge graph that comprises the at least one entity and/or the relation is determined as a function of the second classification. Two entities and a relation represent a fact in the knowledge graph. This means that the second classification is used to determine a fact that is added to the knowledge graph.

According to an example embodiment of the present invention, it can be provided to determine a signal for controlling an actuator, in particular of the technical system, as a function of the second classification. As a result, the technical system can be influenced as a function of the second classification.

According to an example embodiment of the present invention, an apparatus for classifying data comprises at least one processor and at least one memory, wherein the at least one memory comprises instructions executable by the at least one processor, upon the execution of which by the at least one processor, the apparatus carries out the method. The apparatus has advantages that correspond to those of the method.

According to an example embodiment of the present invention, it can be provided that the apparatus comprises a sensor for detecting the data, or is designed to receive the data at an interface, or that the apparatus has an actuator, in particular of a technical system, which can be controlled by a signal from the apparatus, or is designed to output a signal for controlling an actuator, in particular of a technical system, via an interface.

According to an example embodiment of the present invention, a program can be provided, wherein the program comprises instructions executable by a computer, upon the execution of which by the computer, the method takes place.

Further advantageous embodiments of the present invention can be found in the following description and the figures.

### BRIEF DESCRIPTION OF THE DRAWINGS

FIG. 1 is a schematic representation of an apparatus for classifying data, according to an example embodiment of the present invention.

FIG. 2 is a flow chart of a method for classifying data, according to an example embodiment of the present invention.

### DETAILED DESCRIPTION OF EXAMPLE EMBODIMENTS

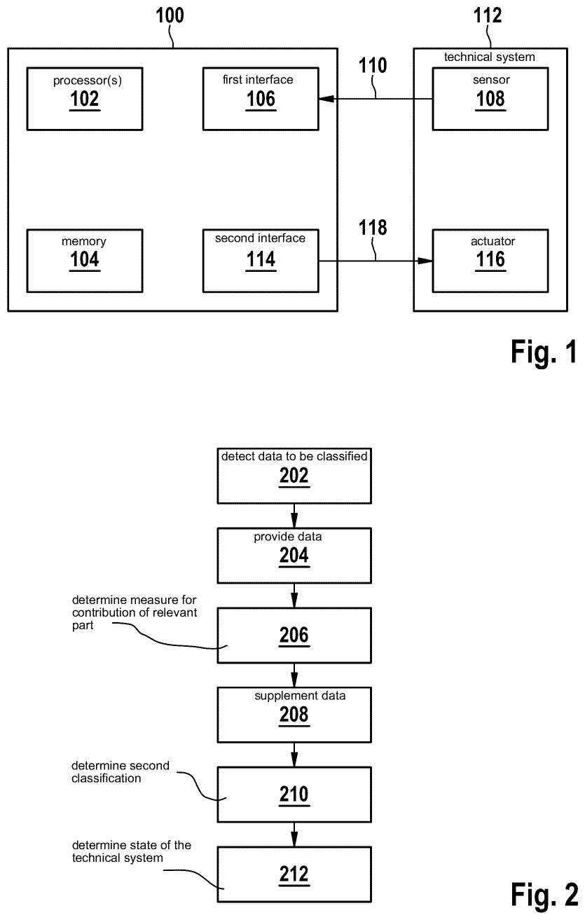

FIG. 1 schematically shows an apparatus 100 for classifying data.

The apparatus 100 comprises at least one processor 102 and at least one memory 104.

It can be provided that the apparatus comprises a first interface 106 for a sensor 108, which is designed to provide parts 110 of the data to be classified. For example, the sensor 108 is designed to detect information about a state of a technical system 112. For example, the apparatus 100 is designed to provide the parts 110 to be classified in a report, for example a log file of the technical system 112.

It can be provided that the apparatus 100 comprises a second interface 114 for an actuator 116, which is designed to influence the technical system 112 as a function of a signal 118 sent by the apparatus 100 to the actuator 116.

The apparatus 100 can comprise the sensor 108 and/or the actuator 116. The technical system 112 can comprise the sensor 108 and/or the actuator 116. The technical system 112 can comprise the apparatus 100.

The at least one memory 104 comprises instructions executable by the at least one processor 102, upon the execution of which by the at least one processor 102, the apparatus 100 carries out a method described below.

A program can be provided that comprises instructions executable by a computer, upon the execution of which by the computer, the method takes place.

The method comprises a step 202.

In step 202, the data 110 to be classified are detected.

For example, the data 110 to be classified are detected as a function of the information about the state of the technical system 112 detected by the sensor 106.

The parts 110 of the data to be classified represent a state of the technical system 112.

A step 204 is subsequently carried out.

In step 204, data are provided for the classification. In the example, the data for the classification comprise the data 110 to be classified.

In one example, the data comprise at least one part that defines a task for which the classification is determined.

In one example, the data comprise at least one part that is masked with a mask.

In one example, the data comprise one or more verbalizers, i.e. at least one part that is associated with a class.

In step 204, an initial classification is determined using a first model as a function of the data.

The first classification comprises a first class for the state of the technical system 112 and a second class for the state of the technical system 112.

It can be provided that the first model is trained to classify the data of the technical system.

It can be provided that the first model for classifying the data of the technical system in the method is trained with data from a training data set for determining the first classification of the data as a function of the data.

The first model can comprise a differentiable model, in particular a transformer model. The model is, for example, BERT or RoBERTa. In a memory-limited system, a comparatively small model such as DistilBERT can be provided. In a system with many computing resources, a comparatively large model such as T5 can be provided.

In one example, the first model is designed to output a first classification specific to the task, as a function of the at least one part that defines the task.

In one example, the first model is designed to determine the part masked with the mask as a function of the first classification.

For example, the first classification allocates a probability to each of the possible solutions for the part marked with the mask.

A step 206 is subsequently carried out.

In step 206, a measure for a contribution of the relevant part to the classification is determined for each of the parts 110 of the data to be classified.

A step 208 is subsequently carried out.

In step 208, the data for the classification are supplemented by at least one of the parts for which, as a function of the dimensions determined for the parts, it is determined that the at least one of the parts 110 to be classified contributes more to the first classification than other parts 110 to be classified.

The data can be supplemented by a predefined number or a predefined percentage of the parts of the data to be classified.

The number or percentage can be a parameter that is predefined or learned in a training session with the training data.

A step 210 is subsequently carried out.

In step 210, a second classification is determined using the first model or a second model as a function of the data supplemented by the at least one of the parts.

The second classification comprises the first class and the second class.

It can be provided that the second model is pre-trained independently of the technical system.

It can be provided that the second model for classifying the data of the technical system in the method is trained using data from a training data set for determining the second classification of the data as a function of the data.

The second model can comprise a differentiable model, in particular a transformer model. The transfer model is, for example, BERT or RoBERTa. In a memory-limited system, a comparatively small model such as DistilBERT can be provided. In a system with many computing resources, a comparatively large model such as T5 can be provided.

In one example, the second model is designed to output a second classification specific to the task, as a function of the at least one part that defines the task.

In one example, the second model is designed to determine the part masked with the mask as a function of the second classification. For example, the second classification allocates a probability to each of the possible solutions for the part marked with the mask.

In one example, the second model is designed to select the part masked with the mask from the second classification as a function of the at least one part associated with the class.

A step 212 is subsequently carried out.

In step 212, the state of the technical system 112 is determined as a function of the second classification.

For example, the state is determined as a function of the class of the second classification, for which the second model determines a greater probability than for the other classes. In the example, a distinction is made between the first class and the second class.

The first class, for example, indicates a first state, for example an error state. The second class, for example, indicates a second state, for example a normal state.

It can be provided that the state is determined as a function of the solution to which the second classification allocates the highest probability.

It can be provided that the parts 110 to be classified comprise a part associated with a first entity from a knowledge graph and a part associated with or a relation from the knowledge graph.

It can be provided that an entry for the knowledge graph, i.e. a fact comprising the first entity and the relation and a second entity, is determined as a function of the second classification. The second classification specifies, for example, a probability for each entity from the knowledge graph that this entity is the second entity in a fact that comprises the first entity, the relation and the second entity. The first entity represents, for example, a state of the technical system 112. The second entity represents, for example, an action for the technical system 112.

It can be provided that the signal 118 for controlling the actuator 116, in particular the technical system 112, is determined as a function of the second classification. For example, the action is determined and the signal 118 is generated for carrying out the action.

The technical system 112 is a physical system, in particular a real existing system. The technical system 112 is, for example, a robot, in particular a vehicle, a tool, a manufacturing machine, a medical device, a household appliance, an access control system or a personal assistance system.

For example, the data to be classified represent an operating temperature of the technical system 112. The parts 110 to be classified are represented by symbols, for example. An example of a state represented by the operating temperature of the technical system 112 is a state in which the operating temperature is above a predefined temperature.

An example of the symbols that comprise the parts 110 to be classified is “operating temperature 50° C.” An example of the task is “is.” An example of the verbalizers is “faulty” or “normal,” wherein the verbalizer “faulty” is assigned to the first class and the verbalizer “normal” to the second class.

An example of the data is “operating temperature 50° C. is [mask].”

An example of the supplemented data is “operating temperature 50° C. is [mask] 50.” For example, “faulty” is determined for the mask as a function of the second classification if the first class has a higher probability than the second class and “normal” is determined otherwise.

The operating temperature is an example of an operating variable of the technical system 112. Other operating variables, in particular physical variables, for example speed or torque or current or voltage or rotation rate or acceleration or speed, can be provided.

It can be provided that a fault is recognized if a check shows that a value of the operating variable is above a permitted threshold. It can be provided that a fault is recognized if a check shows that a value of the operating variable is below a permitted threshold. The threshold is defined, for example, depending on the technical system 112.

For example, the signal 118 for switching off the actuator 116 or the technical system 112 is output if a fault is recognized, i.e. in the example the operating variable is classified as “faulty,” and otherwise no signal 118 for switching off the actuator 116 or the technical system 112 is output.

1-13. (canceled)

14. A computer-implemented method for classifying data, the method comprising the following steps:
determining a first classification as a function of the data using a first model;
determining a measure for a contribution of each relevant part to a classification for parts of the data to be classified;
supplementing data by at least one of the parts, for which, as a function of the measures determined for the parts, it is determined that the at least one of the parts to be classified contributes more to the first classification than other parts to be classified; and
determining a second classification is a function of the data supplemented by the at least one of the parts using the first model or using a second model.

15. The method according to claim 14, wherein the parts of the data to be classified represent a state of a technical system, wherein the first classification includes a first class for the state of the technical system and a second class for the state of the technical system, wherein the second classification includes the first class and the second class, and wherein the state is determined as a function of the second classification.

16. The method according to claim 15, wherein the second classification is determined using the second model, wherein the first model is or will be trained to classify the data of the technical system, wherein the second model is or will be pre-trained independently of the technical system.

17. The method according to claim 14, wherein the first model and/or the second model includes a differentiable model.

18. The method according to claim 14, wherein the first model and/or the second model includes a transformer model.

19. The method according to claim 14, wherein the data include at least one part that defines a task for which the classification is determined.

20. The method according to claim 14, wherein the data include at least one part that is masked with a mask, wherein the first model and/or the second model is configured to determine the part masked with the mask as a function of the first classification or as a function of the second classification.

21. The method according to claim 20, wherein the data include at least one part associated with a class, wherein the first model and/or the second model is configured to select the part masked with the mask from the first classification or the second classification as a function of the at least one part associated with the class.

22. The method according to claim 14, wherein the data are supplemented by a predefined number or a predefined percentage of the parts of the data to be classified.

23. The method according to claim 14, wherein the data include a part that is associated with at least one entity or relation from a knowledge graph, wherein an entry for the knowledge graph that includes the at least one entity and/or relation is determined as a function of the second classification.

24. The method according to claim 14, further comprising:
determining a signal for controlling an actuator of the technical system as a function of the second classification.

25. An apparatus for classifying data, comprising:
at least one processor; and
at least one memory, wherein the at least one memory stores executable instructions for classifying data, the instructions, when executed by the at least one processor, causing the at least one processor to perform the following steps:
determining a first classification as a function of the data using a first model;
determining a measure for a contribution of each relevant part to a classification for parts of the data to be classified;
supplementing data by at least one of the parts, for which, as a function of the measures determined for the parts, it is determined that the at least one of the parts to be classified contributes more to the first classification than other parts to be classified; and
determining a second classification is a function of the data supplemented by the at least one of the parts using the first model or using a second model.

26. The apparatus according to claim 25, wherein:
(i) the apparatus further comprises a sensor configured to detect a part of the data to be classified, or
(ii) the apparatus is configured to receive the part of the data to be classified at an interface, or
(iii) the apparatus further comprises an actuator of the technical system, which can be controlled by a signal from the apparatus, or
(iv) the apparatus is configured to output a signal for controlling the actuator of the technical system, via an interface.

27. A non-transitory computer-readable medium on which is stored a program, including instructions for classifying data, the instructions, when executed by a computer, causing the computer to perform the following steps:
determining a first classification as a function of the data using a first model;
determining a measure for a contribution of each relevant part to a classification for parts of the data to be classified;
supplementing data by at least one of the parts, for which, as a function of the measures determined for the parts, it is determined that the at least one of the parts to be classified contributes more to the first classification than other parts to be classified; and
determining a second classification is a function of the data supplemented by the at least one of the parts using the first model or using a second model.
